(19) United States
(12) Patent Application Publication
(10) Pub. No.: US 2024/0019371 A1
(43) Pub. Date: Jan. 18, 2024

(54) IMAGING SYSTEM AND METHOD OF OPERATION

(71) Applicant: Micrographia Bio Limited, London (GB)

(72) Inventor: Christopher C. THOMPSON, London (GB)

(21) Appl. No.: 18/477,975

(22) Filed: Sep. 29, 2023

Related U.S. Application Data
(63) Continuation of application No. PCT/EP2022/058672, filed on Mar. 31, 2022.

(30) Foreign Application Priority Data
Apr. 1, 2021 (GB) 2104759.2

(51) Int. Cl. G01N 21/64; G01N 1/28; G02B 21/36; G02B 21/16; G02B 21/24

(52) U.S. Cl. CPC G01N 21/6428; G01N 21/6458; G01N 1/28; G02B 21/367; G02B 21/16; G02B 21/24

(57) ABSTRACT

An imaging system and a method of operating an imaging system for imaging a biological target is provided. The imaging system comprises a fluorescence microscope, a light source, an imaging device, a processor, a probe reagent, and a chemical buffer. The method comprises: acquiring, by the imaging device and through the fluorescence microscope, a first image of the biological target at a first time; determining, by the processor, a first value of an image acquisition metric of the first image; determining, by the processor, a first difference between the first value of the image acquisition metric and a predetermined value of the image acquisition metric; adjusting, by the processor, one or more physical parameters of the imaging system based on the first difference, wherein the one or more physical parameters of the imaging system comprise one or more of: an illumination characteristic of the light source, concentration of the probe reagent, and concentration of the chemical buffer; and repeating the steps for a second image acquired at a second time subsequent to the first time.

This application is a bypass continuation of International Application No. PCT/EP2022/058672, filed Mar. 31, 2022, which claims the benefit of priority of United Kingdom Application No. 2104759.2, filed Apr. 1, 2021, the disclosures of each are hereby incorporated by reference as if written herein in their entireties.

### TECHNICAL FIELD

The invention relates to an imaging system for imaging a biological target and a method of operating an imaging system for imaging a biological target.

### BACKGROUND ART

Fluorescence microscopy is a staple component of life science and pharmaceutical research. Many areas of life science and pharmaceutical research rely heavily on fluorescence microscopy to observe biological targets at the sub-cellular level, allowing sub-cellular components to be imaged at high resolutions. Increasingly, automation is being used to acquire images with fluorescence microscopes. For example, it is known that fluorescence microscopes can be automated to acquire images over a period of time (e.g. periodically). These automation methods have advantages over manual operation of fluorescence microscopes, including being unsupervised, having increased throughput, and the acquired images having lower batch-to-batch variation.

However, in molecular and cell biology, uncontrolled systematic variations, such as small changes in probe reagent composition and cell density of the biological target, can have a profound impact on the images acquired by a fluorescence microscope. Known automation does not account for these variations, resulting in inconsistencies between the images which are acquired. These inconsistencies include, for example, inconsistent focus (i.e. blurring), inconsistent fluorescence intensity, etc. Typically, a significant amount of analysis is performed once, after the image acquisition has completed, to correct for artefacts arising from these inconsistencies. Such inconsistencies are commonly referred to as “batch”, “well”, or “seed” effects.

Uncontrolled systematic variations are particularly problematic in Single Molecule Localization Microscopy (SMLM) and other fluorescence imaging techniques that are able to acquire images having higher resolutions than those imposed by the Abbe diffraction limit. These fluorescence imaging techniques achieve high resolutions by acquiring images of fluorescence emission events over a period of time, fitting a localisation function (e.g. a point spread function) to each of the fluorescence emission events to determine precise locations of single molecules, and forming a reconstructed image based on the precise locations. The transient nature of the fluorescence emission events allows for temporal separation of molecules that could not otherwise have been resolved spatially, i.e. because they are located so close to each other that the signals would be indistinguishable were they to have been imaged using standard fluorescence microscopy. One example of SMLM is Stochastic optical reconstruction microscopy (STORM) (see e.g. Rust, M. J., Bates, M., & Zhuang, X. (2006). Sub-diffraction-limit imaging by stochastic optical reconstruction microscopy (STORM). Nature methods, 3(10), 793-796). Another example of SMLM is DNA Point Accumulation Imaging in Nanoscale Topography (DNA-PAINT) (see e.g. Schnitzbauer, J., Strauss, M. T., Schlichthaerle, T., Schueder, F., and Jungmann, R. (2017), Super-resolution microscopy with DNA-PAINT. Nat. Protocols 12, 1198-1228).

Uncontrolled systemic variations are particularly problematic in SMLM due to their impact on the rate of fluorescence emission events, referred to herein as the fluorescence blinking rate. Although fluorescence emission events are stochastic and therefore difficult to control a priori, the average fluorescence blinking rate sets the optimum number of images to be acquired to form a well-sampled reconstructed image. In particular, for a set number of images, if fluorescence emission events are too infrequent, the reduced sampling of the underlying biological target will yield a sparsely reconstructed image, i.e. an image in which molecules present in the biological target are missing. On the other hand, if fluorescence emission events are too frequent, the oversampling of the underlying biological target will lead to increased computer processing, slow image acquisition, and increased potential for reconstruction artefacts. Thus, for SMLM, in addition to the inconsistencies mentioned above, there can also be inconsistencies in how well sampled the fluorescence emission events are in the reconstructed image.

Accordingly, whilst known automation methods for fluorescence microscopy are useful, such techniques have not been able to eliminate inconsistencies between the images which are acquired, particularly for SMLM.

### SUMMARY

In a first aspect of the invention, there is provided a method of operating an imaging system for imaging a biological target, the imaging system comprising a fluorescence microscope, a light source, an imaging device, a processor, a probe reagent, and a chemical buffer, the method comprising:
A. acquiring, by the imaging device and the fluorescence microscope, a first image of the biological target at a first time;
B. determining, by the processor, a first value of an image acquisition metric of the first image;
C. determining, by the processor, a first difference between the first value of the image acquisition metric and a predetermined value of the image acquisition metric;
D. adjusting, by the processor, one or more physical parameters of the imaging system based on the first difference, wherein the one or more physical parameters of the imaging system comprise one or more of: an illumination characteristic of the light source, concentration of the probe reagent, and concentration of the chemical buffer; and
E. repeating steps A to D for a second image acquired at a second time subsequent to the first time.

By using the difference between a first (measured) value of an image acquisition metric and a predetermined value, it can be determined whether there is a change in fluorescence blinking rate. Then, responsive to this change, the processor adjusts physical parameters of the imaging system (namely an illumination characteristic of the light source, concentration of the probe reagent, and/or concentration of the chemical buffer) to change the fluorescence blinking rate. The steps are then repeated for a second subsequently acquired image, and so on. It is this cyclical adjustment of the physical parameters in response to changes in the image acquisition metric that causes the fluorescence blinking rate to be maintained closer to a constant rate than known automation techniques. As a consequence, a reconstructed image, which is reconstructed from the acquired images (i.e. the first and second images), is appropriately sampled (i.e. not oversampled or undersampled).

Optionally, at least two of the one or more physical parameters may be adjusted in step D. By changing more than one of the physical parameters in this way, it may be possible to obtain a greater change in the fluorescence blinking rate between two different images than would otherwise be possible when changing only one of the physical parameters. For the greatest possible rate of change of fluorescence blinking rate, each of the one or more physical parameters may be adjusted in step D.

Optionally, adjusting the illumination power of the light source may comprise: sending an instruction, from the processor to the light source, to change the illumination characteristic. Optionally, adjusting the concentration of the probe reagent may comprise: sending an instruction, from the processor to a microfluidic device, to increase or decrease the concentration of the probe reagent. Optionally, adjusting the concentration of the chemical buffer comprises: sending an instruction, from the processor to a microfluidic device, to increase or decrease the concentration of the chemical buffer. By sending instructions in this way, the processor is able to cause a change to the fluorescence blinking rate without any human intervention. This is desirable as human intervention causes inconsistencies in the images acquired to increase.

Optionally, the image acquisition metric may be based on pixel fluorescent intensity distribution, may be based on stochastic fluorescent events, or may be acutance. Each of these image acquisition metrics is a metric that changes with fluorescence blinking rate. As a consequence, the image acquisition metric indicates a change in fluorescence blinking rate which is used to cause an adjustment one or more physical parameters of the imaging system, thereby responding to the change in fluorescence blinking rate.

In certain embodiments, the method may further comprise obtaining, using a temperature sensor, a first temperature of the biological target at the first time; and determining, by the processor, a first difference between the first temperature and a predetermined temperature. Changes in temperature of the biological sample cause the location of the image plane within the biological sample to move. When this movement is in the z-axis (directly towards or away from the objective lens of the fluorescence microscope), the images that are acquired will appear out of focus because the image plane has moved. Accordingly, temperature of the biological target may be obtained in order to determine whether there have been any changes in the location of the image plane within the biological sample.

In such embodiments, the one or more physical parameters may further comprise a distance between an objective lens of fluorescence microscope and a mechanical platform. In this way, it is possible to counter changes in temperature and therefore change in the image plane location by changing the location of the mechanical platform. Optionally, adjusting the distance between the objective lens of the fluorescence microscope and the biological target may comprises: sending an instruction, from the processor to the mechanical platform, to electromechanically change the mechanical platform location. Thus, countering the changes in the image plane location may be performed without human intervention, which would otherwise introduce inconsistencies to the acquired images.

In such embodiments, the one or more physical parameters may further comprise the biological target temperature. This is an alternative way of countering changes in temperature and therefore change in the image plane location. Optionally, adjusting the biological target temperature may comprise sending an instruction, from the processor to a heating and/or cooling device located adjacent to a chamber containing the biological target, to provide heating or cooling to the chamber. Alternatively, adjusting the biological target temperature may comprise sending an instruction, from the processor to a heating and/or cooling device located adjacent to a tube that connects to a chamber containing the biological target, to provide heating or cooling to the tube; and sending an instruction, from the processor to a microfluidic device, to circulate the chemical buffer through the chamber and the tube. Thus, again, countering the changes in the image plane location may be performed without human intervention, which would otherwise introduce inconsistencies to the acquired images.

Optionally, adjusting, by the processor, one or more physical parameters based on the first difference may comprise determining one or more physical parameter control metrics that are proportional to the first difference. This ensures that the amount that the physical parameters are adjusted is relative to the change in the image acquisition metric and therefore the change of fluorescence blinking rate (and image plane location). Optionally, adjusting, by the processor, one or more physical parameters based on the first difference further comprises determining one or more physical parameter control metrics that are an integral of the first difference and any preceding differences. This ensures that once the image acquisition metric reaches a steady state that the value of the image acquisition metric will be the predetermined value. Optionally, adjusting, by the processor, one or more physical parameters based on the first difference further comprises determining a derivative of the first difference and any preceding differences. This ensures that any response caused by the proportional and integral control metrics is dampened so as to stop significant oscillations in the physical parameters. Preferably, adjusting, by the processor, one or more physical parameters based on the first difference is performed using a proportional-integral-derivative (PID) algorithm. This has all the advantages of having a proportional control metric, an integral control metric and a derivative control metric.

Optionally, steps A to D may be repeated for an nth image acquired at an nth time subsequent to the n−1th time. By acquiring a set of images over time in this way, it is possible to show changes in the biological sample over time. In SMLM where there are stochastic fluorescence emission events over time, each image depicts different fluorescence emission events and therefore different molecules within the biological target. This means the set of images can be used to localise individual molecules that would not otherwise have been discernible.

Optionally, the processor may form a reconstructed image of the biological target using the first image, second image . . . n−1th image and nth image. In this way, the localised individual molecules obtained from each of the images in SMLM are combined into a single reconstructed image which best represents the biological target. Optionally, the reconstructed image may be output to a display and/or stored in a memory.

Optionally, the processor may select one of the first image, second image . . . n−1th image and nth image. When SMLM is not used, there is no need to reconstruct an image. Instead, one of the images from the set of images is selected as a standard reference to reduce the inconsistencies between selected images of different biological targets. Optionally, the selected image may be output to a display and/or stored in a memory.

In a second aspect of the invention, there is provided an imaging system for imaging a biological target, the imaging system comprising: a fluorescence microscope; an imaging device optically coupled to the fluorescence microscope, wherein the imaging device is configured to acquire a first image of the biological target using the fluorescence microscope at a first time and a second image of the biological target using the fluorescence microscope at a second time at a second time subsequent to the first time; a light source; a chemical buffer; a probe reagent; and a processor configured to:
A. determine a first value of an image acquisition metric of the first image;
B. determine a first difference between the first value of the image acquisition metric and a predetermined value of the image acquisition metric;
C. adjust one or more physical parameters based on the first difference, wherein the one or more physical parameters comprise one or more of: an illumination characteristic of the light source, concentration of the probe reagent, and concentration of the chemical buffer; and
D. repeat steps A to C for the second image.

### BRIEF DESCRIPTION OF DRAWINGS

Embodiments of the invention are described below, by way of example, with reference to the following drawings, in which:

FIG. 1 is a schematic illustrating an exemplary imaging system of the invention for maintaining fluorescence blinking rate.

FIG. 2 is a schematic illustrating an exemplary biological sample of the invention.

FIG. 3 is schematic illustrating an exemplary microfluidic device of the invention.

FIG. 4A and FIG. 4B are schematics illustrating exemplary imaging systems of the invention for maintaining temperature.

FIG. 5 is a flow diagram of an exemplary method of the invention for operating an imaging system.

### DETAILED DESCRIPTION

### Imaging System

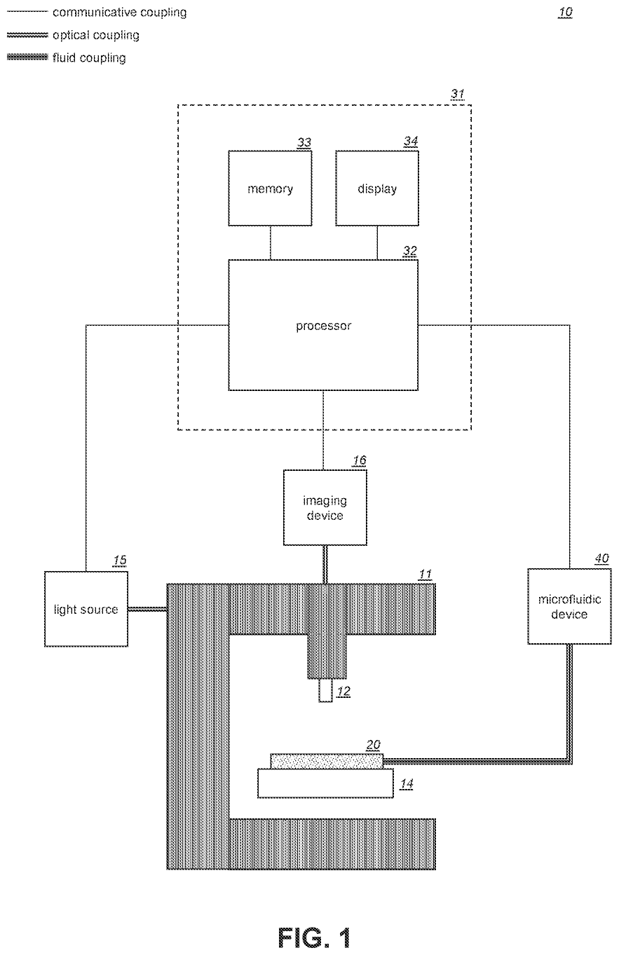

FIG. 1 is a schematic showing imaging system 10 for imaging a biological target 21. As shown in FIG. 1, imaging system 10 comprises fluorescence microscope 11. Fluorescence microscope 11 is a microscope that uses fluorescence instead of, or in addition to, scatting, reflection and attention or absorption, to generate an image. Commercially available fluorescence microscopes, such as the DM B series of microscopes by Leica Microsystems GmbH or the Eclipse range of microscopes by Nikon Metrology UK Ltd (Derby), may be used in imaging system 10.

Fluorescence microscope 11 includes an objective lens 12 which transmits and focuses light from a light source 15 onto biological sample 20 which contains biological target 21. When light of a particular wavelength (or wavelengths) illuminates biological sample 20, the light is absorbed by the fluorophores of the biological sample 20, causing the fluorophores to emit light of a different wavelength than the absorbed light. The light that is emitted by the fluorophores is received by objective lens 12 and transmitted to an imaging device 16. Therefore, as shown in FIG. 1, fluorescence microscope 11, light source 15 and imaging device 16 are optically coupled. The phrases “optically coupled” and “optical coupling” as used herein means coupled by an optical fibre or free space optics. The term “light” as used herein is a reference to electromagnetic wavelengths in the visible spectrum.

Fluorescence microscope 11 receives light from light source 15. Light source 15 may form an integral part of fluorescence microscope 11, or may be separate from fluorescence microscope 11. Light source 15 has various illumination characteristics. An illumination characteristic, as used herein, is a characteristic of the light that is output by light source 15 (including any components considered to form part of light source 15, such as a colour filter or an electro-optic modulator). Example illumination characteristics include wavelength, output power, collimation, coherence, polarisation, spatial and temporal profiles, and monochromaticity. In the invention, one or more illumination characteristics of light source 15 may be adjusted whilst image acquisition is in process. Preferably, output power is adjusted.

Light source 15 is preferably a laser because of the inherent illumination characteristics of lasers. Inherent illumination characteristics of lasers include monochromaticity, coherence, and collimation. Alternatively, light source 15 may be a light emitting diode (LED). LEDs do not have the same inherent illumination characteristics as lasers, but similar illumination characteristics may be achieved through other means. For instance, one or more of a colour filter, a slit, and a collimator, may be used in conjunction with an LED to achieve similar illumination characteristics as a laser. In some embodiments, light source 15 may comprise a plurality of lasers and/or LEDs which each have different illumination characteristics.

As mentioned, output power of light source 15 is an illumination characteristic that may be adjusted during image acquisition. This adjustment can be achieved using various techniques. For instance, the output power of the light source 15 may be adjusted by changing an output power setting on the light source 15. Alternatively, output power of the light source 15 may be adjusted by changing the input power to light source 15, thereby changing the output power of light source 15. Alternatively or additionally, light source 15 may comprise an electro-optic modulator. Electro-optic modulators use the electro-optic effect to modulate the amplitude of light received from the laser or LED. Electro-optic modulators which modulate other illumination characteristics may also be used in imaging system 10, including polarisation modulation and phase modulation.

Wavelength is also an illumination characteristic of light source 15 that may be adjusted during image acquisition. Light source 15 emits light of specific wavelength or wavelengths depending on the type of light source that is used. For example, Gallium nitride (GaN) laser diodes have an emission wavelength between 360 nm and 480 nm (e.g. 450 nm). In another example, “Warm White” LEDs emit wavelengths primarily between 500 nm and 700 nm. The specific wavelength (or wavelengths) will typically be chosen based on the biological sample 20 and the excitation wavelength of the fluorophores. To adjust the wavelength which is emitted, a different laser which emits light of a different specific wavelength may be used. Commercially available fluorescence microscopes are typically able to transmit at five or six different wavelengths. Alternatively, light source 15 may comprise a colour filter to filter certain wavelengths emitted by an LED. In some instances, more than one colour filter may be used. For instance, a mechanical colour filter wheel may comprise a plurality of different colour filters that are selected by rotating the wheel appropriately.

Once the light has been received at the biological sample 20, and caused fluorophores to emit light, the fluorescence is received by objective lens 12 and transmitted to imaging device 16. Imaging device 16 converts the light that is received to an image, which for the purpose of the invention is a digital image. Imaging device 16 comprises a camera. Two types of camera that are suitable for imaging device 16 include Charge Coupled Devices (CCD) cameras and scientific Complementary Metal Oxide Semiconductors (sCMOS) cameras. These types of cameras have high sensitivity and low noise, which enables the cameras to detect often low levels of fluorescence emitted by biological target 21 with minimal noise. Commercially available cameras for fluorescence imaging that can be used with the invention include the Scientifica SciCam Pro, the Photometrics Prime 95B sCMOS, and the Hamamatsu Orca Flash 4.0 LT Plus.

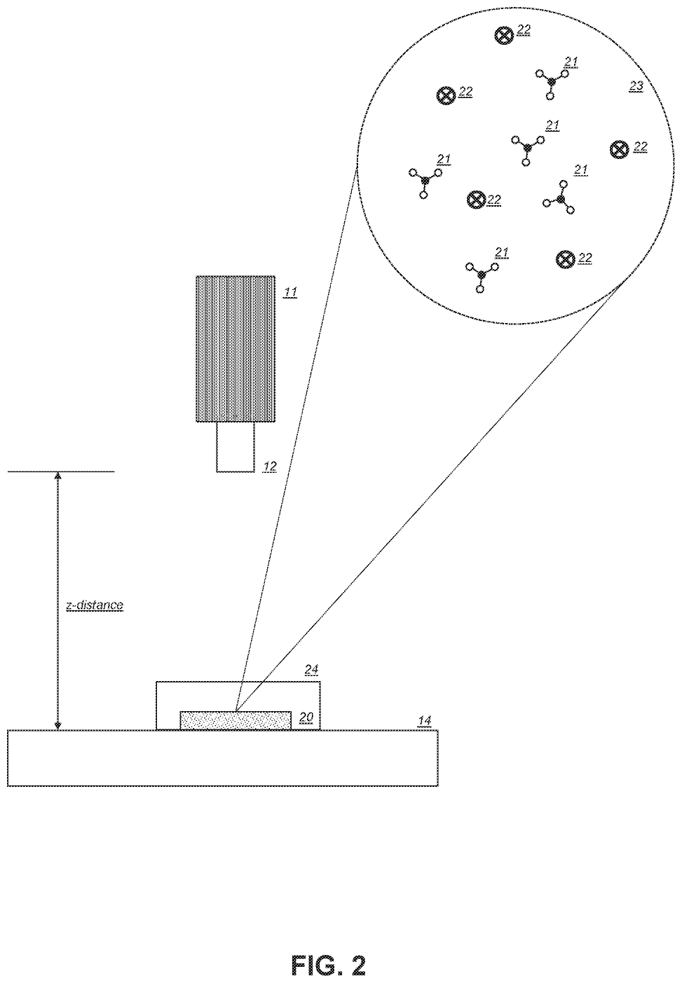

As shown in both FIG. 1, biological sample 20, which comprises biological target 21, is positioned on a platform 14. Platform 14 may be a mechanical platform (denoted herein as mechanical platform 54). The distance between platform 14 and objective lens 12 is referred to herein as the z-distance, which is the distance in the z-axis. The z-distance is shown in FIG. 2. The platform 14 extends in a plane that is perpendicular to the z-axis (i.e. in the x-y plane).

FIG. 2 shows biological sample 20 from FIG. 1 in further detail. Biological sample 20 is contained in chamber 24 and placed on platform 14 of the fluorescence microscope. As shown in FIG. 2, biological sample 20 is formed of biological target 21, probe reagent 22, and chemical buffer 23. Each of biological target 21, probe reagent 22 and chemical buffer 23 have a certain concentration within biological sample 20.

Biological target 21 will in general comprise one or more cells (e.g. a population of cells), or may comprise a cell lysate from a cell or a population of cells. Biological target 21 may contain prokaryotic or eukaryotic cells, e.g. animal, plant, yeast, bacterial or other cells. The cells are preferably animal cells. They may be of animal original and may in particular be of mammalian origin. They may be primary cells or may be cells that are a cell line, e.g. a mammalian cell line. Biological target 21 may contain cells that are from an animal model of a disease or a human or animal patient with a disease. Biological target 21 may be from an animal (preferably a mammal such as a human or an experimental animal e.g. a mouse or rat) and the sample may e.g. by blood, sputum, lymph, mucous, stool, urine and the like. Biological target 21 may be a tissue sample such as a tissue section. Biological target 21 may be an environmental sample such as a water sample, an air sample, a food sample, and the like. FIG. 2 shows individual molecules of biological target 21.

Probe reagent 22 is made up of fluorescent probes. Fluorescent probes are molecules that absorb light of a specific wavelength and emit light of a different, typically longer, wavelength (a process known as fluorescence). The molecules, also known as fluorophores, are attached to the molecules of the biological target 21 and act as a marker for analysis with fluorescence microscopy. These fluorophores are shown in FIG. 2. Biological sample 20 may contain one type of probe reagent 22, which makes it possible to resolve one type of molecule of biological target 21. Alternatively, biological sample 20 may contain a plurality of different types of probe reagent, which makes it possible to resolve a plurality of different types of molecules of biological target 21.

For SMLM, suitable probe reagents 22 do not cause constant fluorescence, but instead discrete fluorescence emission events over time. The transient nature of the fluorescence emission events allows for temporal separation of molecules that could not otherwise have been resolved spatially, i.e. because they are located so close to each other that the signals would be indistinguishable were they to have been imaged using standard fluorescence microscopy. The type of probe reagent 22 used depends on the type of SMLM. Suitable probe reagents for STORM are discussed in Rust, M. J., Bates, M., & Zhuang, X. (2006). Sub-diffraction-limit imaging by stochastic optical reconstruction microscopy (STORM). Nature methods, 3(10), 793-796). Suitable probe reagents for DNA-PAINT are discussed in Schnitzbauer, J., Strauss, M. T., Schlichthaerle, T., Schueder, F., and Jungmann, R. (2017), Super-resolution microscopy with DNA-PAINT. Nat. Protocols 12, 1198-1228).

Biological sample 20 also contains chemical buffer 23. Chemical buffer 23 is an aqueous solution into which probe reagent 22 is dissolved.

With reference back to FIG. 1, imaging device 16 is communicatively coupled to a processor 32. As used herein “communicative coupling” and “communicatively coupled” means coupled via a communication link. The communication link may take many different forms such as an Internet-based link, a cellular link, or a link between machine interfaces. Typical machine interfaces used with processor 32, when embodied in a computer system 31, include USB-A and USB-C. The communicative coupling between imaging device 16 and processor 32 means that images which are acquired by imaging device 16 can be sent to processor 32. Light source 15 is also communicatively coupled to the processor 32 so that the processor can send instructions to the light source 15 to control illumination characteristics of the light source. Similarly, microfluidic device 40 is communicatively coupled to the processor 32 so that the processor can send instructions to the microfluidic device 40 to increase or decrease the concentration of probe reagent 22 and/or chemical buffer 23.

Processor 32 may be part of computer system 31, as shown in FIG. 1. Computer system 31 is typically a personal computer such as a desktop computer or laptop computer. Components of computer system 31 other than processor 31 include, for example, memory 33, display 34 and I/O devices such as a keyboard and mouse (not shown). Memory 33 may take the form of: random access memory (RAM) for temporary storage of data; read only memory (ROM) for permanent storage of information; a mass storage device, such as a hard drive, solid state drive, USB device, or optical media storage device; or a combination of the above. In imaging system 10, memory 33 is used to store images acquired by the imaging device 11 and reconstructed images formed by processor 32. Display 34 includes a screen that is able to display images acquired by imaging device 11 and reconstructed images to a user of imaging system 10. The I/O devices allow the user to interact with the processor 32 to perform various tasks such as viewing images, overriding imaging system operation algorithms, and the like.

Alternatively or additionally, processor 32 may be at least partially encapsulated in an electronic device such as a proportional-integral-derivative (PID) controller (not shown). In certain embodiments, processor 32 comprises a plurality of PID controllers, each PID controller corresponding to a different physical parameter of the imaging system 10. For example, there may be three PID controllers corresponding to an illumination characteristic of light source 15, concentration of probe reagent 22, and concentration of chemical buffer 23, respectively. Alternatively, there may be five PID controllers corresponding to an illumination characteristic of light source 15, concentration of probe reagent 22, concentration of chemical buffer 23, the distance between objective lens 12 of fluorescence microscope 11 and the mechanical platform 54 (i.e. the z-distance), and the biological target 21 temperature, respectively. Commercially available PID controllers, such as the universal PID controller by Omega Engineering Inc., may be used in imaging system 10.

When processor 32 is partially encapsulated in an electronic device, a computer system 31 with a further processor may still be used in conjunction with the electronic device. In this way, processor 32 may incorporate a plurality of processors. In one particular embodiment, a plurality of PID controllers are used in conjunction with a computer system 31 having its own processor. In another embodiment, a plurality of PID controllers and a separate microcontroller are used in conjunction with a computer system 31 having its own processor.

As shown in FIG. 1, biological sample 20 is fluidly coupled to a microfluidic device 40. The phases “fluidly coupled” and “fluid coupling” mean coupled by a tube or a channel that is suitable for fluid transport. The purpose of microfluidic device 40 is to change the concentration of probe reagent 22 and the concentration of chemical buffer 23 of the biological sample 20 within the chamber 24. Microfluidic device 40 is communicatively coupled to processor 32 so that the microfluidic device 40 can receive instructions sent from processor 32 to change the concentration of probe reagent 22 and/or chemical buffer 23.

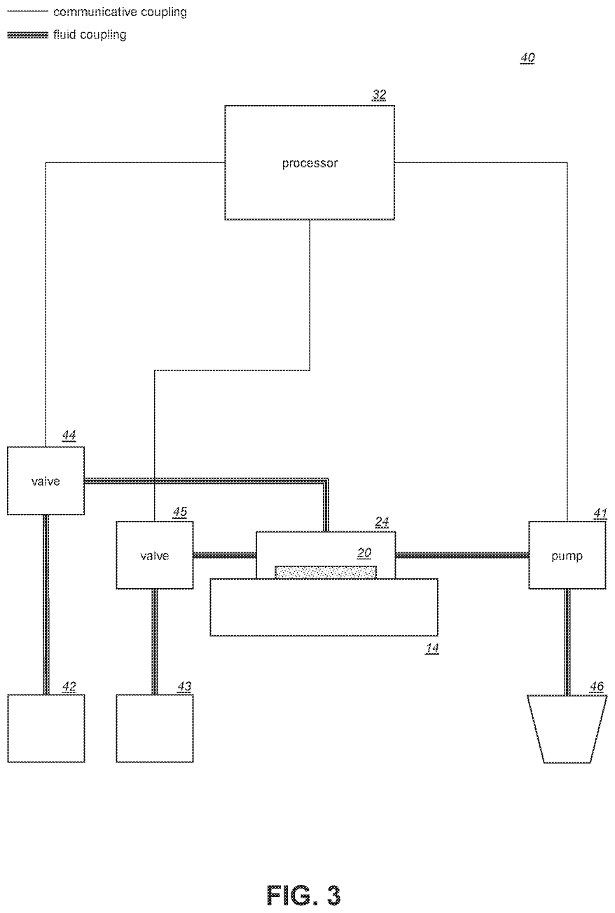

FIG. 3 shows a detailed example of microfluidic device 40. Microfluidic device 40 is connected to chamber 24 through at least one ingress tube (preferably two, one fluidly coupled to switch 44 and one fluidly coupled to switch 45) and an egress tube. Microfluidic device 40 comprises a pump 41, such as a peristaltic pump, which draws chemical buffer 24 from chamber 24, through the egress tube, and out to waste 46.

Microfluidic device 40 also includes a chemical buffer reservoir 43 which stores chemical buffer 23. Chemical buffer reservoir 43 is fluidly coupled to chamber 24 via chemical buffer valve 45 and an ingress tube. When chemical buffer valve 45 is closed and pump 41 is activated, chemical buffer 24 flows from chamber 24 to waste outlet 46. However, chemical buffer 24 cannot flow from the chemical buffer reservoir 43 into chamber 24 due to the chemical buffer valve 45. This causes the concentration of the chemical buffer 23 to decrease. In contrast, when chemical buffer valve 45 is open, chemical buffer 23 flows from the chemical buffer reservoir 43 into chamber 24. This cause the concentration of probe reagent 22 in chamber 24 to decrease, thereby increasing the concentration of chemical buffer 23 (relatively) in chamber 24.

Microfluidic device 40 also includes a probe reagent reservoir 42 which stores probe reagent 22. Probe reagent reservoir 42 is fluidly coupled to chamber 24 via probe reagent valve 44 and an ingress tube. The operation of the probe reagent valve 44 is the same as the chemical buffer valve 45 discussed above.

Chemical buffer valve 45 and probe reagent valve 44 are electro-mechanical valves, each of which opens and closes in response to instructions from processor 32. In some instances, such as when processor 32 is part of a computer system 31, an additional microcontroller may be required to interface chemical buffer valve 45 and probe reagent valve 44 with processor 32 of computer system 32 (either one additional microcontroller for both valves, or one additional microcontroller for each of the valves). The additional microcontroller may be, for example, an Arduino single-board microcontroller.

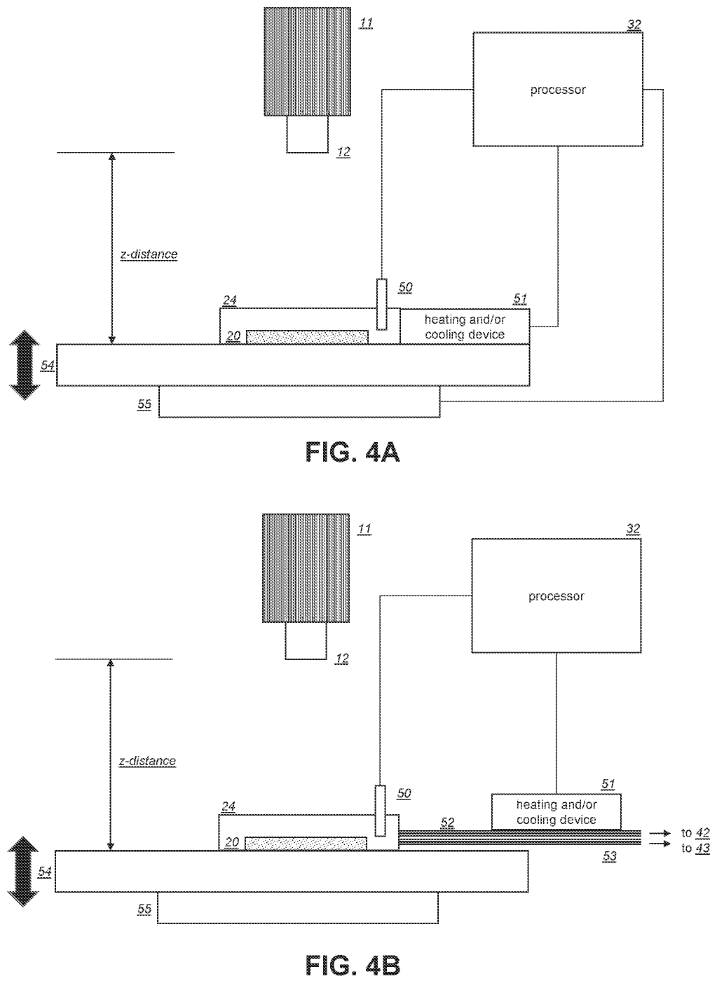

By adjusting an illumination characteristic of light source 15, concentration of the probe reagent 22, and concentration of chemical buffer 23, using the imaging system 10 of FIG. 1, FIG. 2 and FIG. 3, the fluorescence blinking rate is maintained throughout the image acquisition process. In certain embodiments, in addition to maintaining the fluorescence blinking rate, the location of the image plane within the biological sample 21 is maintained. FIG. 4A and FIG. 4B show different embodiments of additional components for imaging system 10, to be used in conjunction with the components in FIG. 1, FIG. 2 and FIG. 3, for maintaining the image plane location.

With reference to FIG. 4A, imaging system 10 additionally comprises a temperature sensor 50. Temperature sensor 50 is located at least partially within chamber 24 and may be in, on or adjacent to the biological sample 20. Temperature sensor 50 is used for obtaining the temperature of the biological target 21. Optionally, a distance sensor (not shown) may be present. The distance sensor measures the z-distance (i.e. the distance between the mechanical platform 54 and objective lens 12). The temperature sensor 50 and the distance sensor are communicatively coupled to processor 32. The measured temperature, or at least a signal indicative of the measured temperature, is sent from temperature sensor 50 to processor 32. Similarly, the measured z-distance, or at least a signal indicative of the measured z-distance, is sent from the distance sensor to processor 32.

In the embodiment of FIG. 4A, platform 14 is a mechanical platform (denoted mechanical platform 54). Mechanical platform 54 is a platform that is able to change location through electromechanical means, without requiring a user to physically adjust the platform.

The electromechanically means, which include gears, electric motors, and the like, are contained within mechanical platform mechanism 55. Processor 32 sends instructions to mechanical platform mechanism 55 to adjust the location of the mechanical platform 54, and in particular the z-distance between the mechanical platform 54 and the objective lens 12.

Processor 32 also sends instructions to a heating and/or cooling device 51. As shown in FIG. 4A, heating and/or cooling device 51 is positioned adjacent to the chamber 24. Heating and/or cooling device 51 may be one device that is capable of both heating and cooling. Alternatively, heating and/or cooling device 51 may comprise a heating device and a cooling device. Examples of a heating device include an infrared heater, a convection heater, an immersion heater, an electrode heater, etc. An example of a cooling device that may be used is a thermocouple. In some instances, mechanical platform 54 itself may be a heating and/or cooling device 51. For instance, mechanical platform 54 may be a heated platform.

The embodiment of FIG. 4B is the same as that of FIG. 4A, except that the heating and/or cooling device 51 is located adjacent to the ingress tubes which connect the chamber 24 to probe reagent reservoir 42 and chemical buffer reservoir 43 (denoted in FIG. 4B as 52 and 53, respectively). In this embodiment, the chemical buffer 23 and/or the probe reagent 22 which flow into the chamber 24 are heated or cooled via heating and/or cooling device 51 so as to heat or cool the biological target 21. There may be one heating and/or cooling device 51 for each of the ingress tubes. Alternatively, the ingress tubes may share one heating and/or cooling device 51. The communicative coupling between mechanical platform mechanism 55 and processor 32 is not shown in FIG. 4B (unlike FIG. 4A) but is present.

In certain instances, it may be useful to combine the embodiments of FIG. 4A and FIG. 4B so that there is a first heating and/or cooling device 51 positioned adjacent to the chamber 24 and a second (or second and third) heating and/or cooling device positioned adjacent to the egress tubes 52, 53.

It will be appreciated that imaging system 10 described above and shown in FIG. 1, FIG. 2, FIG. 3 and FIG. 4 is an example imaging system for use with methods of the invention. Imaging system 10 may include additional, fewer or alternative components. For instance, known components that are used in fluorescence microscopy, and in particular in SMLM, may be used within imaging system 10.

### Method of Operating the Imaging System

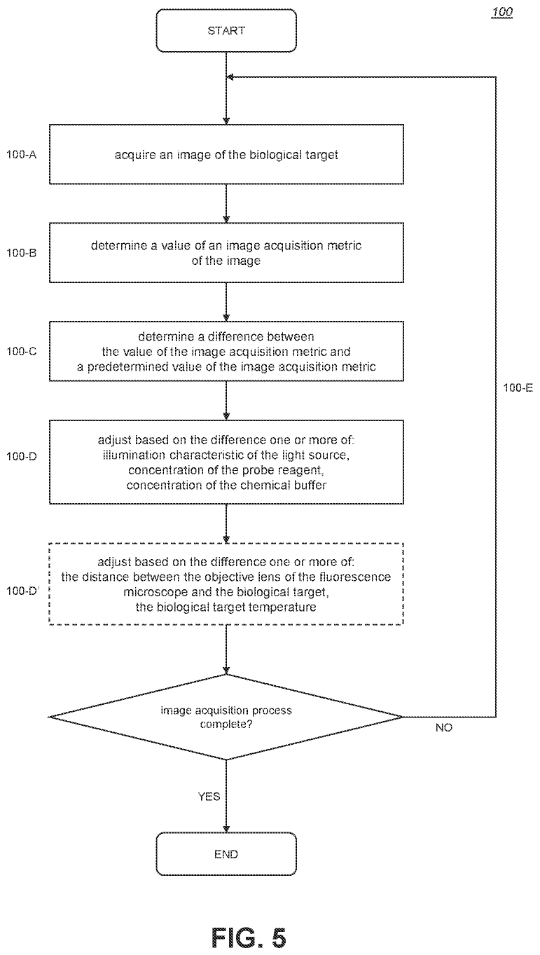

FIG. 5 shows a method 100 for operating imaging system 10 for imaging a biological target 21. The method comprises the following steps: acquiring an image of the biological target (step 100-A); determining a value of an image acquisition metric of the image (step 100-B); determining a difference between the value of the image acquisition metric and a predetermined value of the image acquisition metric (step 100-C); adjusting based on the difference one or more of: an illumination power characteristic of the light source, concentration of the probe reagent and concentration of the chemical buffer (step 100-D); and repeating steps 100-A to 100-D (step 100-E). FIG. 5 also shows step 100-D′, adjusting based on the difference one or more of: the distance between the objective lens of the fluorescence microscope and the biological target and the biological target temperature, which is an optional step. Each of these steps is discussed in detail below.

Prior to method 100 commencing, a user of the imaging system 10 may set up various image acquisition parameters by interacting with processor 32 through the I/O device. Possible image acquisition parameters include the number of images to be acquired, the period between acquiring each image, a start time for acquiring images, an end time for acquiring images, predetermined value(s) of the image acquisition metric(s), and the like. The method may start when the user interacts with processor 32 to instruct the processor 32 to begin image acquisition or as a consequence of a set start time for acquiring images. When method 100 commences, light source 15 is turned on so as to illuminate the biological target 21.

At step 100-A, an image of biological target 21 is acquired. Light emitted from light source 15 is transmitted through objective lens 12 of fluorescence microscope 11 and on to biological target 21 (and the rest of the biological sample 20). The biological target 21 fluoresces and this fluorescence is transmitted through the objective lens 12 to imaging device 16. The imaging device 16 then converts the light that is received to a digital image. The image acquisition may be instigated by the processor 32 sending an instruction to the imaging device 16 for an image to be acquired. Alternatively, the imaging device 16 may be programmed to capture images periodically. Periodic image acquisition is discussed further in step 100-E. Once the image has been acquired, the image is sent to processor 32 and stored in memory 33. Optionally, the image may be displayed on display 34.

In step 100-B, processor 32 determines a value (i.e. a numerical value) of an image acquisition metric for the image that was acquired in step 100-A. The processor may determine the value for a single acquisition metric or values for a plurality of different acquisition metrics. For example, values for two, three, or more different image acquisition metrics may be determined. Particular image acquisition metrics for use with the invention, and methods for determining image acquisition metrics, are discussed further herein.

In step 100-C, processor 32 determines the difference between the value of the image acquisition metric that was determined in step 100-B and a predetermined value of the image acquisition metric. This is performed by subtracting the value of the image acquisition metric from the predetermined value of the image acquisition metric. The difference may be stored in memory 33 for use in step 100-D. Methods for determining the predetermined value of an image acquisition metric are discussed in conjunction with the particular image acquisition metrics further herein.

At step 100-D, processor 32 adjusts one or more physical parameters of the imaging system based on the difference determined in step 100-C, where the one or more physical parameters comprise one or more of: an illumination characteristic of the light source 15, concentration of the probe reagent 22 and concentration of the chemical buffer 23. This involves processor 32 sending an instruction to at least one other component of imaging system 10 (e.g. light source 15, microfluidic device 40) to effectuate the desired adjustment to the one or more physical parameters of the imaging system 10. In other words, processor 32 causes adjustment of the one or more physical parameters. The relationships between the physical parameters and the instructions sent by processor 32 are discussed in detail below.

As discussed elsewhere herein, the advantage of adjusting one or more of an illumination characteristic of the light source 15, concentration of the probe reagent 22 and concentration of the chemical buffer 23, is that the fluorescence blinking rate can be maintained at a constant rate. In some embodiments, one of these physical parameter of the imaging system 10 is adjusted based on the difference. In other embodiments, two of these physical parameters of the imaging system 10 are adjusted based on the difference. In further embodiments, all three of these physical parameters of the imaging system 10 are adjusted based on the difference.

Optionally, in step 100-D′, processor 32 may adjust further physical parameters based on the difference, wherein the one or more further physical parameters comprise the distance between the objective lens 12 of the fluorescence microscope 11 and the biological target 21 (i.e. the z-distance) and the biological target 21 temperature. Like step 100-D, step 100-D′ involves processor 32 sending an instruction to at least one other component of imaging system 10 (e.g. heating and/or cooling device 51, mechanical platform 54) to effectuate the desired adjustment to the one or more further physical parameters of the imaging system 10. In other words, processor 32 causes adjustment of the one or more further physical parameters. The relationships between the further physical parameters and the instructions sent by processor 32 are also discussed in detail below.

As discussed elsewhere herein, the advantage of adjusting one or more of the distance between the objective lens 12 of the fluorescence microscope 11 and the mechanical platform 54 (i.e. the z-distance) and the biological target 21 temperature is that the image plane can be maintained at a constant location. In some embodiments, one of these further physical parameter of the imaging system 10 is adjusted based on the difference. In other embodiments, both of these further physical parameters of the imaging system 10 are adjusted based on the difference.

When optional step 100-D′ is being used, the temperature of the biological target 21 may be used in addition to or instead of the image acquisition metric for step 100-D′. Temperature sensor 50 measures the temperature of the biological target 21, either in response to an instruction from processor 32 or continuously. The measured temperature (or a signal indicate of the measured temperature) is sent to processor 32. Processor 32 determines the difference between the measured temperature and a predetermined temperature, and this difference may be used in step 100-D′ to adjust the distance between the objective lens 12 of the fluorescence microscope 11 and the biological target 21 (i.e. the z-distance) and the biological target 21 temperature. Note that the adjustment in step 100-D is still uses the image acquisition metric.

The adjustment that is performed in step 100-D is determined based on the difference between the measured image acquisition metric and the predetermined image acquisition metric. This difference is indicative of how the one or more parameters should be adjusted to ensure that the fluorescence blinking rate is maintained at a constant level. For instance, a relatively large negative value in the difference may indicate that a particular physical parameter should be increased by a relatively large amount, whilst a relatively small positive value in the difference may indicate that the particular physical parameter should be decreased by a relatively small amount. Processor 32 uses the difference to determine one or more physical parameter control metrics. Each of the one or more physical parameter control metrics corresponds to one of the one or more physical parameters.

The adjustment that is performed in step 100-D′ is similar to that of step 100-D, except that the difference may relate either to the measured image acquisition metric and the predetermined image acquisition metric, or the measured temperature and the predetermined temperature.

The one or more physical parameter control metrics can be determined by processor 32 using different techniques. In one embodiment, the one or more physical parameter control metrics may be proportional to the difference (i.e. include a proportional component only). In another embodiment, the one or more physical parameter control metrics may include a proportional component as well as an integral component. The integral component is determined based on an integral of the difference and any preceding differences that have been determined by processor 32 previously.

In a preferred embodiment, the one or more physical parameter control metrics includes a proportional component, an integral component and a derivative component. The derivative component is determined based on a derivative of the difference and any preceding differences that have been determined by processor 32 previously. In this embodiment, adjusting the one or more physical parameters is performed by processor 32 using a proportional-integral-derivative (PID) algorithm. The PID algorithm may be performed by processor 32 as part of a computer system 31, or by separate PID controllers. A different PID controller may be used for each of the one or more physical parameters.

The invention is not limited to using a PID algorithm. Processor 32 may use other algorithms for adjusting the one or more physical parameters. For example, processor 32 may use a control model that is trained using machine learning, such as a reinforcement machine learning algorithm.

Once step 100-D (or step 100-D′, if being used) has been performed, processor 32 determines whether the image acquisition process has completed or not. In this context, the image acquisition process is not a reference to step 100-A, where an image is acquired, but instead to the process of capturing a set of images which can be used to reconstruct an image of biological target. This determination may the image acquisition parameters set by the user, such as the end time or the total number of images to be captured, or may be triggered by an instruction from the user to end the image acquisition process. If the image acquisition process is deemed by processor 32 to have been completed, then method 100 ends. If the image acquisition process is deemed by processor 32 not to be completed, then steps 100-A, 100-B, 100-C and 100-D (and optionally 100-D′) are repeated for a further image, as shown by step 100-E. The images are acquired sequentially, such that the time of acquiring the further image is subsequent to the time of acquiring the initial image.

As steps 100-A to 100-D (and optionally 100-D′) are repeated at least once, a set of images is acquired by method 100 of FIG. 5. The total number of images acquired in the image acquisition process is denoted herein as n, where n is a positive integer that is greater or equal to 2. There may be a set period of time between acquiring each image in the set of images. This set period of time may be included in the image acquisition parameters input by the user.

When n=2, the initial image acquired in the step 100-A is denoted herein as the “first image”, the initial value determined in step 100-B is the “first value”, and the initial difference determined in step 100-C is the “first difference”. Then, the further image acquired in the repeated step 100-A is denoted herein as the “second image”, the value determined in repeated step 100-B is the “second value” and the difference determined in repeated step 100-C is the “second difference”, etc.

### Image Acquisition Metrics

An image acquisition metric is a numerical metric that is obtained using an image that has been acquired using imaging device 18 and through fluorescence microscope 11, as shown in step 100-A of method 100 of FIG. 5.

Image acquisition metrics used in the method of FIG. 5 for maintaining the fluorescence blinking rate are metrics that change when there is a change to the fluorescence blinking rate. Preferably, the image acquisition metric for maintaining the fluorescence blinking rate is based on pixel fluorescent intensity distribution, based on stochastic fluorescent events, and/or acutance. Each of these image acquisition metrics, methods for determining the respective image acquisition metrics and methods for determining the predetermined value of the respective image acquisition metrics are discussed below.

Metrics used in the method of FIG. 5 for maintaining the image plane location are metrics that change when there is a change to the image plane location. For instance, the acutance may be used as an image acquisition metric for maintaining the image plane location. Instead of or in addition to this image acquisition metric, the biological target temperature may be used.

### Pixel Fluorescent Intensity Distribution

When imaging device 16 converts fluorescent light that it receives to a digital image, each pixel of said image is assigned an amplitude based on the intensity of fluorescence received. The distribution of amplitudes across the pixels therefore corresponds to the distribution of fluorescence intensity across the pixels, referred to herein as the pixel fluorescent intensity distribution. The pixel fluorescent intensity distribution gives an indication of fluorescence blinking rate because the amplitudes of the pixels are the result of fluorescence emission events, where higher amplitudes denote more fluorescence emission events.

Whilst pixel fluorescent intensity distribution cannot be an image acquisition metric per se (because it is a distribution, not a metric), various metrics may be used to characterise the pixel fluorescent intensity distribution. For example, the pixel fluorescence intensity distribution may be characterised by one or more of: mean, variance, skewness, and kurtosis of the pixel fluorescence intensity distribution. Any of these metrics of the fluorescence intensity distribution are suitable for use with the invention. Computer implemented methods for calculating such metrics are known, see for example Virtanen, P., Gommers, R., Oliphant, T. E. et al. SciPy 1.0: fundamental algorithms for scientific computing in Python. Nat Methods 17, 261-272 (2020).

To determine the predetermined value of one or more metrics of the pixel fluorescent intensity distribution, an image of the biological target 21 is manually acquired before method 100 commences and said one or more metrics calculated using the manually acquired image. The predetermined value of one or more metrics of the pixel fluorescent intensity distribution is then set as the calculated metrics.

### Stochastic Fluorescent Events

The number of stochastic fluorescence events per image may be used as an image acquisition metric. Stochastic fluorescent events are also referred to herein as fluorescence emission events. Although such events are stochastic for each individual molecule, the number of events for the biological target 21 generally and therefore across the image as a whole is indicative of the fluorescence blinking rate.

Computer implemented methods for identifying and calculating the number of stochastic fluorescent events in an image are known. For example, stochastic fluorescent events may be distinguished using computer vision filter pipelines, such as the one described at https://scikit-image.org/docs/dev/auto_examples/features_detection/plot_blob.html. Alternatively, algorithms used for SMLM, such as STORM or DNA-PAINT, include steps in which stochastic fluorescence events are identified. Such steps can be used to identify then calculate the number of stochastic fluorescent events in each image.

The predetermined value for the number of stochastic fluorescence events in an image is calculated to optimise the probability that only a single molecule within a diffraction limited region is illuminated per image. This probability follow a Poisson distribution and is calculated empirically prior to method 100 commencing. Various aspects of imaging system 10, such as the exposure time for each image, may be used in this calculation. The predetermined value for the number of stochastic fluorescence events in an image may be used to determine the total number of images that should be captured to form a well-sampled reconstructed image.

### Acutance

Acutance describes the sharpness of an image and, in the context of the invention, describes the rate of transition between pixels pertaining to fluorescence emission events and pixels pertaining to the background. As more fluorescence emission events are present in the image, the acutance tends to increase. As a consequence, the acutance is indicative of the fluorescence blinking rate.

Acutance is calculated by determining the mean value of a gradient filter function. Gradient filter functions give the magnitude of the gradient of the pixels, computed using discrete derivatives of a Gaussian of sample radius. See for example Wolfram Research (2008), GradientFilter, Wolfram Language function, https://reference.wolfram.com/language/ref/GradientFilter.html (updated 2016).

To determine the predetermined value of acutance, an image of the biological target 21 is manually acquired before method 100 commences and said acutance calculated using the manually acquired image.

### Biological Target Temperature

The biological target temperature is not an image acquisition metric per se because it is not determined using the image, but may similarly be used for determining a difference and then an adjustment.

The temperature of the biological target 21 is determined by measuring biological target 21 with temperature sensor 50. The predetermined value may be the initial temperature of the biological target 31 before method 100 commences. In this case, the predetermined value is determined by measuring with a temperature sensor prior to method 100 commencing, and setting this measured value as the predetermined value.

### Adjusting Physical Parameters of the Imaging System

In steps 100-D one or more physical parameters are adjusted and in step 100-D′ one or more further physical parameters are adjusted. As mentioned in conjunction with FIG. 5, each of these steps involves the processor sending an instruction to at least one other component of imaging system 10 (e.g. light source 15, microfluidic device 40, heating and/or cooling device 51, mechanical platform 54). These instructions and the corresponding physical parameter are discussed in detail below.

### Illumination Characteristic of the Light Source

Adjusting an illumination characteristic of the light source involves an instruction being sent from processor 22 to light source 16 to change the illumination characteristic.

When the illumination characteristic is output power, the instruction that is sent to light source 16 cause the laser or LED to change its own output power. Alternatively, the instruction may be sent to the electro-optic modulator to change the amplitude modulation of the light emitted from the laser or LED.

Assuming that all other physical parameters are maintained at a constant level, decreasing the output power typically causes the fluorescence blinking rate to decrease whilst increasing the output power typically causes the fluorescence blinking rate to increase. However, because fluorescence emission events are scholastic, this relationship will not always be observed.

### Concentration of the Chemical Buffer

Adjusting concentration of chemical buffer 23 involves an instruction being sent from processor 32 to microfluidic device 40 to increase or decrease the concentration of chemical buffer 23.

In particular, when the concentration of chemical buffer 23 is to be increased, processor 32 sends an instruction to chemical buffer valve 45 to open. Chemical buffer 23 then flows from chemical buffer reservoir 43 to chamber 24. When the concentration of chemical buffer 23 is to be decreased, processor 32 sends an instruction to the chemical buffer valve 45 to close. A further instruction is sent by processor 32 to pump 41, and the chemical buffer 23 is pumped out to waste 46.

Assuming that all other physical parameters are maintained at a constant level, increasing the concentration of the chemical buffer 23 typically causes the fluorescence blinking rate to decrease whilst decreasing the concentration of the chemical buffer 23 typically causes the fluorescence blinking rate to increase. This is because increasing the concentration of the chemical buffer 23 causes the concentration of the probe reagent 22 to decrease. However, because fluorescence emission events are scholastic, this relationship will not always be observed.

### Concentration of the Probe Reagent

Adjusting concentration of probe reagent 22 involves an instruction being sent from processor 32 to microfluidic device to increase or decrease the concentration of probe reagent 22.

Concentration of the probe reagent 22 is adjusted in the same manner as the chemical buffer.

Assuming that all other physical parameters are maintained at a constant level, decreasing the concentration of the probe regent 22 typically causes the fluorescence blinking rate to decrease whilst increasing the concentration of the probe regent 22 typical causes the fluorescence blinking rate to increase. However, because fluorescence emission events are scholastic, this relationship will not always be observed.

### Z-Distance

Adjusting the z-distance, which is the distance between the objective lens 12 and the biological target 21, involves an instruction being sent to mechanical platform 54 of FIG. 4A and FIG. 4B in order to electromechanically change the location of the mechanical platform 54.

In particular, when the z-distance is to be increased, processor 32 sends an instruction to mechanical platform mechanism 55 to move the mechanical platform 54 away from the objective lens 12 in the z-axis (i.e. lowers the mechanical platform). When the z-distance is to be decreased, processor 32 sends an instruction to mechanical platform mechanism 55 to move the mechanical platform 54 towards the objective lens 12 in the z-avis (i.e. raises the mechanical platform 54).

### Biological Target Temperature

Adjusting the biological target temperature involves sending instructions to heating and/or cooling device in the embodiment of FIG. 4A, or heating and/or cooling device and microfluidic device 40 in the embodiment of FIG. 4B.

In particular, in the embodiment of FIG. 4A, adjusting the biological target temperature comprises sending an instruction, from processor 32 to heating and/or cooling device 51 located adjacent to chamber 24 containing the biological target 21, to provide heating or cooling to the chamber.

In the embodiment of FIG. 4B, adjusting the biological target temperature comprises sending an instruction, from processor 32 to heating and/or cooling device 51 located adjacent to at least one ingress tube 52, 53 that connects to chamber 24 containing the biological target 21 to provide heating or cooling to the at least one ingress tube 52, 53. In addition, an instruction is sent from processor 32 to microfluidic device 40, to circulate the chemical buffer 23 or the probe reagent 22 through the chamber 24.

### Image Selection or Reconstruction

A set of images is acquired during the image acquisition method 100, with a total of n images captured, where n is a positive integer that is greater or equal to 2. For example, n may be 10 images, 100 images, 1,000 images, 10,000 images, 100,000 images, etc.

In some embodiments, the set of images is used to form a (single) reconstructed image of the biological target 21. Various computer implemented methods for forming a reconstructed image are known for SMLM. In general for SMLM, each of the set of images captures different fluorescence emission events. Localisation functions (e.g. a point spread function) are fit to each of the fluorescence emission events to determine precise locations of single molecules of biological target 21 for the reconstructed image, and the reconstructed image is formed based on the precise locations. Example SMLM techniques include STORM and DNA-PAINT, as discussed herein.

Another method for forming a reconstructed image which may be used with the image acquisition method 100 is described in GB application no. 2102391.6 (MICROGRAPHIA BIO LIMITED).

Once the reconstructed image has been generated, the reconstructed image may be output to display 34 for the user to view. Additionally or alternatively, the reconstructed image may be stored in memory 33. The user can retrieve the reconstructed image at a later time from memory 33.

In other embodiments, for example where SMLM is not being used, rather than using the set of images to form a reconstructed image of the biological target 21, one of the set of images is selected. For example, when a proportional-integral-derivative algorithm is used, the last image that is captured (n=n) during method 100 may be selected by processor 32. The imaging system 10 is most likely to be at steady state during the last image. Alternatively, a user may interact with processor 32 and manually select one of the set of images.

Like the reconstructed image, the selected image may be output to display 34 for the user to view. Additionally or alternatively, the selected image may be stored in memory 33. The user can retrieve the selected image at a later time from memory 33.

### General

As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

The flow diagrams in the figures illustrate the architecture, functionality, and operation of possible implementations of methods according to various embodiments of the present invention. In this regard, each block in the flow diagram performed by processor 32 may represent a module, segment, or portion of code, which comprises one or more executable instructions for implementing the specified logical function(s). It will also be noted that each block of the flow diagrams performed by processor 32, and combinations of blocks in the flow diagrams performed by processor 32, can be implemented by special purpose hardware-based systems that perform the specified functions or acts, such as the PID controllers discussed herein, or combinations of special purpose hardware and computer instructions.

The invention can take the form of an entirely hardware embodiment, including the PID controllers discussed herein, an entirely software embodiment, such as the computer system 31 discussed herein, or an embodiment containing both hardware and software elements.

When implemented at least partly in software, the invention includes a computer program embodied as a computer-readable medium having computer executable code for use by or in connection with computer system 31. For the purposes of this description, a computer-readable medium can be any tangible apparatus that can contain, store, communicate, propagate, or transport the program for use by or in connection with the computer. For instance, a computer-readable medium can be an electronic, magnetic, optical, electromagnetic, infrared, or semiconductor system (or apparatus or device) or a propagation medium. Particular examples of a computer-readable medium include a solid state memory, a RAM, a ROM, a rigid magnetic disk, an optical disk and the like. Examples of optical disks include compact disk-read only memory (CD-ROM), compact disk-read/write (CD-R/W), DVD, and Blu-Ray.

It will be understood that the above description of is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the scope of this invention.

### Embodiments

The following list provides embodiments of the invention and forms part of the description. These embodiments can be combined in any compatible combination beyond those expressly stated. The embodiments can also be combined with any compatible features described herein:
1. A method of operating an imaging system for imaging a biological target, the imaging system comprising a fluorescence microscope, a light source, an imaging device, a processor, a probe reagent, and a chemical buffer, the method comprising: A. acquiring, by the imaging device and the fluorescence microscope, a first image of the biological target at a first time; B. determining, by the processor, a first value of an image acquisition metric of the first image; C. determining, by the processor, a first difference between the first value of the image acquisition metric and a predetermined value of the image acquisition metric; D. adjusting, by the processor, one or more physical parameters of the imaging system based on the first difference, wherein the one or more physical parameters of the imaging system comprise one or more of: an illumination characteristic of the light source, concentration of the probe reagent, and concentration of the chemical buffer; and E. repeating steps A to D for a second image acquired at a second time subsequent to the first time.
2. The method of embodiment 1, wherein the image acquisition metric is based on pixel fluorescent intensity distribution.
3. The method of embodiment 1, wherein the image acquisition metric is based on stochastic fluorescent events.
4. The method of embodiment 1, wherein the image acquisition metric is acutance.
5. The method of any preceding embodiment, wherein adjusting the illumination power of the light source comprises: sending an instruction, from the processor to the light source, to change the illumination characteristic.
6. The method of any preceding embodiment, wherein adjusting the concentration of the probe reagent comprises: sending an instruction, from the processor to a microfluidic device, to increase or decrease the concentration of the probe reagent.
7. The method of any preceding embodiment, wherein adjusting the concentration of the chemical buffer comprises: sending an instruction, from the processor to a microfluidic device, to increase or decrease the concentration of the chemical buffer.
8. The method of any preceding embodiment, further comprising: obtaining, using a temperature sensor, a first temperature of the biological target at the first time; and determining, by the processor, a first difference between the first temperature and a predetermined temperature.
9. The method of embodiment 8, wherein the one or more physical parameters further comprise a distance between an objective lens of fluorescence microscope and a mechanical platform.
10. The method of embodiment 9, where adjusting the distance between the objective lens of the fluorescence microscope and the biological target comprises: sending an instruction, from the processor to the mechanical platform, to electromechanically change the mechanical platform location.
11. The method of any of embodiments 8 to 10, wherein the one or more physical parameters further comprise the biological target temperature.
12. The method of embodiment 11, wherein adjusting the biological target temperature comprises: sending an instruction, from the processor to a heating and/or cooling device located adjacent to a chamber containing the biological target, to provide heating or cooling to the chamber.
13. The method of embodiment 11, wherein adjusting the biological target temperature comprises: sending an instruction, from the processor to a heating and/or cooling device located adjacent to a tube that connects to a chamber containing the biological target, to provide heating or cooling to the tube; and sending an instruction, from the processor to a microfluidic device, to circulate the chemical buffer through the chamber and the tube.
14. The method of any preceding embodiment, wherein adjusting, by the processor, one or more physical parameters based on the first difference comprises determining one or more physical parameter control metrics that are proportional to the first difference.
15. The method of embodiment 14, wherein adjusting, by the processor, one or more physical parameters based on the first difference further comprises determining one or more physical parameter control metrics that are an integral of the first difference and any preceding differences.
16. The method of embodiment 15, wherein adjusting, by the processor, one or more physical parameters based on the first difference further comprises determining a derivative of the first difference and any preceding differences.
17. The method of embodiment 16, wherein adjusting, by the processor, one or more physical parameters based on the first difference is performed using a proportional-integral-derivative (PID) algorithm.
18. The method of any preceding embodiment, wherein at least two of the one or more physical parameters are adjusted.
19. The method of any preceding embodiment, wherein each of the one or more physical parameters are adjusted.
20. The method any preceding embodiment, further comprising: forming, by the processor, a reconstructed image of the biological target using the first image and the second image.
21. The method any preceding embodiment, further comprising: selecting, by the processor, one of the first image and the second image.
22. The method of any preceding embodiment, further comprising: repeating steps A to D for an nth image acquired at an nth time subsequent to the n−1th time.
23. The method of embodiment 22, further comprising: forming, by the processor, a reconstructed image of the biological target using the first image, second image . . . n−1th image and nth image.
24. The method of embodiment 22, further comprising: selecting, by the processor, one of the first image, second image . . . n−1th image and nth image.
25. The method of embodiment 20 or 23, further comprising: outputting the reconstructed image to a display and/or storing the reconstructed image in a memory.
26. The method of embodiment 21 or 24, further comprising: outputting the selected image to a display and/or storing the selected image in a memory.
27. An imaging system for imaging a biological target, the imaging system comprising: a fluorescence microscope; an imaging device optically coupled to the fluorescence microscope, wherein the imaging device is configured to acquire a first image of the biological target using the fluorescence microscope at a first time and a second image of the biological target using the fluorescence microscope at a second time at a second time subsequent to the first time; a light source; a chemical buffer; a probe reagent; and a processor configured to: A. determine a first value of an image acquisition metric of the first image; B. determine a first difference between the first value of the image acquisition metric and a predetermined value of the image acquisition metric; C. adjust one or more physical parameters based on the first difference, wherein the one or more physical parameters comprise one or more of: an illumination characteristic of the light source, concentration of the probe reagent, and concentration of the chemical buffer; and D. repeat steps A to C for the second image.
28. The system of embodiment 27, wherein the image acquisition metric is based on pixel fluorescent intensity distribution.
29. The system of embodiment 27, wherein the image acquisition metric is based on stochastic fluorescent events.
30. The system of embodiment 27, wherein the image acquisition metric is acutance.
31. The system of any of embodiments 27 to 30, wherein the processor is further configured to adjust the illumination characteristic of the light source by sending an instruction, from the processor to the light source, to change the illumination characteristic.
32. The system of any of embodiments 27 to 31, further comprising a microfluidic device, wherein the processor is further configured to adjust the concentration of the probe reagent by sending an instruction, from the processor to the microfluidic device, to increase or decrease the concentration of the probe reagent.
33. The system of any of embodiments 27 to 32, further comprising a microfluidic device wherein the processor is further configured to adjust the concentration of the chemical buffer by sending an instruction, from the processor to the microfluidic device, to increase or decrease the concentration of the chemical buffer.
34. The system of any of embodiments 27 to 32, further comprising a temperature sensor configured to obtain a first temperature of the biological target at the first time, wherein the processor is further configured to determine a first difference between the first temperature and a predetermined temperature.
35. The system of embodiment 34, wherein the fluorescence microscope comprises an objective lens and a mechanical platform, and wherein the one or more physical parameters further comprises a distance between the objective lens and the mechanical platform.
36. The system of embodiment 35, wherein the processor is further configured to adjust the distance between the objective lens and the biological target by sending an instruction, from the processor to the mechanical platform, to electromechanically change the mechanical platform location.
37. The system of any of embodiments 34 to 37, wherein the one or more physical parameters further comprises the biological target temperature.
38. The system of embodiment 37, further comprising a chamber containing the biological target and a heating and/or cooling device located adjacent to a chamber, wherein the processor is further configured to adjust the biological target temperature by sending an instruction, from the processor to the heating and/or cooling device, to provide heating or cooling to the chamber.
39. The system of embodiment 37, further comprising a chamber containing the biological target, a tube connected to the chamber, a microfluidic device, and a heating and/or cooling device located adjacent to the tube, wherein the processor is further configured to adjust the biological target temperature by sending an instruction, from the processor to the heating and/or cooling device, to provide heating or cooling to the tube and sending an instruction, from the processor to the microfluidic device, to circulate the chemical buffer through the chamber and the tube.
40. The system of any of embodiments 27 to 39, wherein the processor is configured to adjust one or more physical parameters based on the first difference by determining one or more physical parameter control metrics that are proportional to the first difference.
41. The system of embodiment 40, wherein the processor is configured to adjust one or more physical parameters based on the first difference by determining one or more physical parameter control metrics that are an integral of the first difference and any preceding differences.
42. The system of embodiment 41, wherein the processor is configured to adjust one or more physical parameters based on the first difference by determining a derivative of the first difference and any preceding differences.
43. The system of embodiment 42, wherein the processor is configured to adjust the one or more physical parameters based on the first difference using a proportional-integral-derivative (PID) algorithm.
44. The system of any of embodiments 27 to 43, wherein at least two of the one or more physical parameters are adjusted.
45. The system of any of embodiments 27 to 44, wherein each of the one or more physical parameters are adjusted.
46. The system of any of embodiments 27 to 45, wherein the processor is further configured to form a reconstructed image of the biological target using the first image and the second image.
47. The system of any of embodiments 27 to 45, wherein the processor is further configured to select one of the first image and the second image.
48. The system of any of embodiments 27 to 45, wherein the imaging device is further configured to acquire an nth image of the biological target at an nth time subsequent to the n−1th time, and the processor is further configured to repeat steps A to C for the nth image.
49. The system of embodiment 48, wherein the processor is further configured to form a reconstructed image of the biological target using the first image, second image . . . n−1th image and nth image.
50. The system of embodiment 48, wherein the processor is further configured to select one of the first image, second image . . . n−1th image and nth image.
51. The system of embodiment 46 or 49, further comprising a display configured to output the reconstructed image and/or a memory configured to store the reconstructed image.
52. The system of embodiment 47 or 50, further comprising a display configured to output the selected image and/or a memory configured to store the selected image.

1. A method of operating an imaging system for imaging a biological target, the imaging system comprising a fluorescence microscope, a light source, an imaging device, a processor, a probe reagent, and a chemical buffer, the method comprising:
A. acquiring, by the imaging device and the fluorescence microscope, a first image of the biological target at a first time;
B. determining, by the processor, a first value of an image acquisition metric of the first image;
C. determining, by the processor, a first difference between the first value of the image acquisition metric and a predetermined value of the image acquisition metric;
D. adjusting, by the processor, one or more physical parameters of the imaging system based on the first difference, wherein the one or more physical parameters of the imaging system comprise one or more of: an illumination characteristic of the light source, concentration of the probe reagent, and concentration of the chemical buffer; and
E. repeating steps A to D for a second image acquired at a second time subsequent to the first time.

2. The method of claim 1, wherein the image acquisition metric is based on pixel fluorescent intensity distribution.

3. The method of claim 1, wherein the image acquisition metric is based on stochastic fluorescent events distribution.

4. The method of claim 1, wherein the image acquisition metric is acutance.

5. The method of any preceding claim, wherein adjusting the illumination power of the light source comprises:
sending an instruction, from the processor to the light source, to change the illumination characteristic.

6. The method of any preceding claim, wherein adjusting the concentration of the probe reagent comprises:
sending an instruction, from the processor to a microfluidic device, to increase or decrease the concentration of the probe reagent.

7. The method of any preceding claim, wherein adjusting the concentration of the chemical buffer comprises:
sending an instruction, from the processor to a microfluidic device, to increase or decrease the concentration of the chemical buffer.

8. The method of any preceding claim, further comprising:
obtaining, using a temperature sensor, a first temperature of the biological target at the first time; and
determining, by the processor, a first difference between the first temperature and a predetermined temperature.

9. The method of claim 8, wherein the one or more physical parameters further comprise a distance between an objective lens of fluorescence microscope and a mechanical platform.

10. The method of claim 9, where adjusting the distance between the objective lens of the fluorescence microscope and the biological target comprises:
sending an instruction, from the processor to the mechanical platform, to electromechanically change the mechanical platform location.

11. The method of any of claims 8 to 10, wherein the one or more physical parameters further comprise the biological target temperature.

12. The method of claim 11, wherein adjusting the biological target temperature comprises:
sending an instruction, from the processor to a heating and/or cooling device located adjacent to a chamber containing the biological target, to provide heating or cooling to the chamber.

13. The method of claim 11, wherein adjusting the biological target temperature comprises:
sending an instruction, from the processor to a heating and/or cooling device located adjacent to a tube that connects to a chamber containing the biological target, to provide heating or cooling to the tube; and
sending an instruction, from the processor to a microfluidic device, to circulate the chemical buffer through the chamber and the tube.

14. The method of any preceding claim, wherein adjusting, by the processor, one or more physical parameters based on the first difference comprises determining one or more physical parameter control metrics that are proportional to the first difference.

15. The method of claim 14, wherein adjusting, by the processor, one or more physical parameters based on the first difference further comprises determining one or more physical parameter control metrics that are an integral of the first difference and any preceding differences.

16. The method of claim 15, wherein adjusting, by the processor, one or more physical parameters based on the first difference further comprises determining a derivative of the first difference and any preceding differences.

17. The method of claim 16, wherein adjusting, by the processor, one or more physical parameters based on the first difference is performed using a proportional-integral-derivative (PID) algorithm.

18. The method of any preceding claim, wherein at least two of the one or more physical parameters are adjusted.

19. The method of any preceding claim, wherein each of the one or more physical parameters are adjusted.

20. The method of any preceding claim, further comprising:
repeating steps A to D for an nth image acquired at an nth time subsequent to the n−1th time.

21. The method of claim 20, further comprising:
forming, by the processor, a reconstructed image of the biological target using the first image, second image . . . n−1th image and nth image.

22. The method of claim 20, further comprising:
selecting, by the processor, one of the first image, second image . . . n−1th image and nth image.

23. The method of claim 21, further comprising:
outputting the reconstructed image to a display and/or storing the reconstructed image in a memory.

24. The method of claim 22, further comprising:
outputting the selected image to a display and/or storing the selected image in a memory.

25. An imaging system for imaging a biological target, the imaging system comprising:
a fluorescence microscope;
an imaging device optically coupled to the fluorescence microscope, wherein the imaging device is configured to acquire a first image of the biological target using the fluorescence microscope at a first time and a second image of the biological target using the fluorescence microscope at a second time at a second time subsequent to the first time;
a light source;
a chemical buffer;
a probe reagent; and
a processor configured to:
A. determine a first value of an image acquisition metric of the first image;
B. determine a first difference between the first value of the image acquisition metric and a predetermined value of the image acquisition metric;
C. adjust one or more physical parameters based on the first difference, wherein the one or more physical parameters comprise one or more of: an illumination characteristic of the light source, concentration of the probe reagent, and concentration of the chemical buffer; and
D. repeat steps A to C for the second image.
